(19) United States
(12) Patent Application Publication
(10) Pub. No.: US 2024/0427981 A1
(43) Pub. Date: Dec. 26, 2024

(54) Auto-generating Custom Websites using User Content, Machine Learning Models, and an Artificial Intelligence Engine

(71) Applicant: Arav Wadhwa, San Ramon, CA (US)

(72) Inventor: Arav Wadhwa, San Ramon, CA (US)

(21) Appl. No.: 18/212,097

(22) Filed: Jun. 20, 2023

(51) Int. Cl. G06F 40/166; G06N 20/00

(52) U.S. Cl. CPC G06F 40/166; G06N 20/00

(57) ABSTRACT

This invention relates to a method using a computer system, for auto-generating custom websites using user content, machine learning models, and an Artificial Intelligence engine. An example of an implementation may include the steps to receive input from a user including user content and user preference, auto generate preferences, generate content, design, and interaction files for web hosting, generate analytics and search engine optimization recommendations based on user behavior, machine learning models, and an Artificial Intelligence engine, to generate custom websites.

### FIELD OF INVENTION

The invention generally relates to the System and Method for auto-generating custom websites using User Content, Machine Learning models, and an Artificial Intelligence Engine.

### BACKGROUND OF THE INVENTION

Creating a website involves knowledge and expertise in various web development technologies. If one has coding experience, they can use languages such as HTML, CSS, and JavaScript to create a website from scratch. Other alternate ways to create a website are using Content Management Systems (CMS) that allow users to create and manage website content, or Website Builders that provide a drag-and-drop interface. Using existing tools in the market, the effort of creating a website involves either designing and creating it yourself or hiring a website developer, and the timeline can range from a few days to a few months. There are some static site generators in the market today, but they are all targeted towards web developers and do not make it possible for someone with no web development knowledge to be able to generate their own website. There are some more recent ways using Generative AI, to generate a website from a hand drawn image or a prompt written in natural language, but it's not feasible if there is a lot of data that needs to be used to generate the website.

### BRIEF SUMMARY OF THE INVENTION

The invention describes methods, and systems needed for auto-generating a custom website. Users may be able to generate a custom website based on content in their file, with no technical or design expertise at all. For example, a custom website may be auto-generated for which the design may be based on the user's personal preference of existing templates and on the content in their excel file or Google Sheet which could be existing or written for the purpose of generating the website.

An aspect of the invention relates to the user content used by the method. The user content may include different types of files. In a typical embodiment, the different types of files may include Excel files, Google sheets, Word documents, Google docs, or an image. This is a non limiting example, and the user content may include other file types not mentioned here.

Another aspect of the invention relates to a method for generating the custom website. The method may include receiving user preference regards to the design. The user preference could be chosen out of a set of available templates. The method may also include determining user preference based on content of the file and amount of data in the file. The method may include generating the website based on the specified user preference or determined user preference.

Another aspect of the invention relates to a method for generating a website. The method may include generating the website with content files including search keywords. Search keywords may be integrated with the content files to uprank the website in search results.

Another aspect of the invention relates to a method for generating search engine optimization data. This module may include a recommendation engine to determine search recommendations.

Another aspect of the present invention relates to a computer system to perform one or more methods for generating a custom website. The method may include receiving user content as input from a user, and getting user preference for the custom website. The method may include determining user preferences based on the user content. The method may include generating config based on the user preferences, auto-determined preferences, and user content. The method may include generating website content based on the user content. The method may include generating templates based on the user input and user content, generating interaction based on the user input and user content, generating social links based on the user input and user content. The method may include generating analytics and search engine optimization recommendations based on the user behavior, machine learning model, and AI recommendation engine. The method may include generating a custom website based on the user preferences and user content, generating a custom website based on the user preferences and user content; and sharing the custom website with the user.

### BRIEF DESCRIPTION OF THE SEVERAL VIEWS OF THE DRAWINGS

The invention will have references to the drawings, in which:

FIG. 1 is a diagram of an example of a custom website generated based on user data in a file, according to the user preferences and auto-determined preferences.

FIG. 2 is an example of a Site Generation Engine creating a custom website based on user content, user preferences, available templates, and a recommendation engine.

FIG. 3 is a functional block diagram of the Computer System and modules that may be needed for generating a custom website.

FIG. 4 is an example of a flow diagram for generating a custom website, based on user content, user preferences, available templates, and a recommendation engine.

During implementation, all depicted modules in each figure may not be required. Some implementations may require less modules. Other implementations may include additional or different modules not shown in a figure here.

### DETAILED DESCRIPTION OF THE INVENTION

The invention provides methods, and systems for auto-generating a custom website. Users may generate a custom website based on content in their file, with no technical or design expertise at all. A user may specify a design preference, or it can be generated based on intelligent system recommendations. For example, a custom website may be auto generated based on the user's input on which design template to use or the system intelligence may decide the design template that should be used will be one with filter functionality because there is a massive amount of data for the website to display.

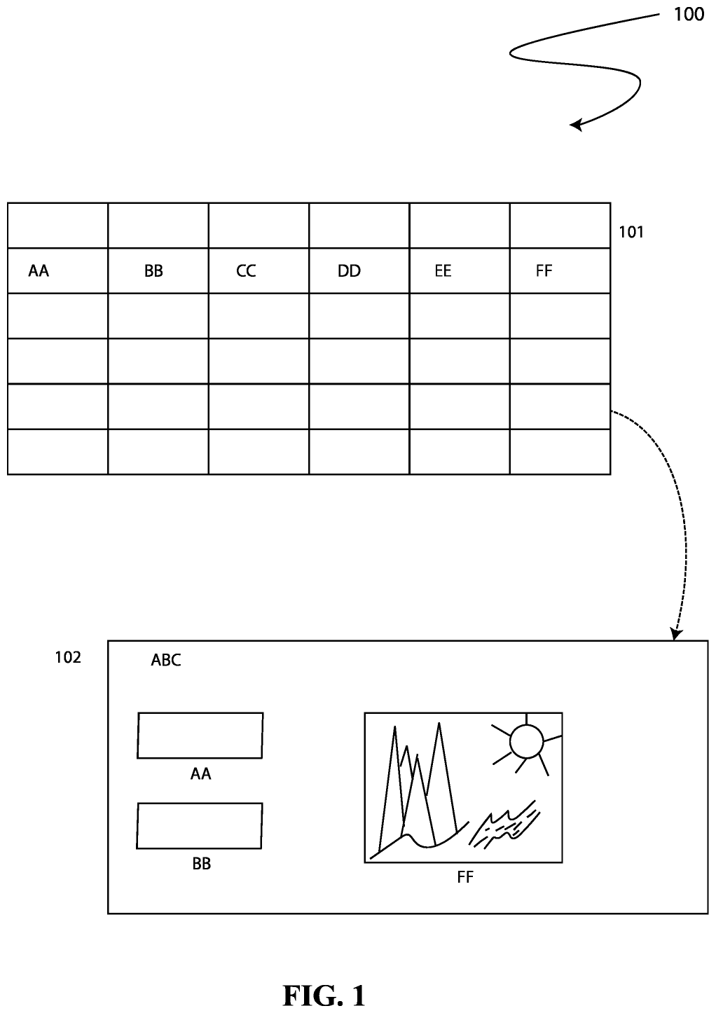

FIG. 1 is a diagram of an example of a custom website auto-generation 100 in which a website 102 is generated based on user content within a user file 101, on the basis of user preferences or determined preferences. The user file 101 may be obtained from or referred-to from one or more of user specified locations. These locations may include digital media, social media, a hyperlink, or any other user defined sources (such as a website or file location), and/or other sources for photos. Design templates for the custom website may be automatically determined by the recommendation engine based on amount and type of user content. For example, machine learning (ML) models may be utilized to automatically determine the custom website design. In a typical embodiment, user content could be in a Google sheet and may have data AA, BB, CC, DD, and EE. FF may be the location of an image file. This data may be used to generate the custom website custom website where the website content includes AA, and BB, and it displays the image file from the location specified in FF.

In addition to website content creation, an important aspect is the ability to increase user traffic and user engagement to the generated website. SEO (Search Engine Optimization) is the process of optimizing a website or web pages to improve their visibility in search engine results pages. Based on standard practices, the following components of SEO can be optimized. Keyword research and optimization involves finding relevant keywords and phrases that people search for and using them throughout the website to help search engines understand the content of the page. On-page optimization involves making changes to the HTML code, content, images, and other elements of a website to improve its relevance and position in the search rankings. Content creation and optimization involves creating relevant content that would attract and engage users, and optimizing it for search engines. Backlink building involves acquiring backlinks from other reputable websites to improve the credibility of your own website. Technical optimization involves ensuring that the website is technically sound and meets search engine guidelines, including elements such as website structure, mobile responsiveness, and website speed. It helps search engines crawl, and index the website more effectively, to help improve organic ranking. User experience optimization involves improving the overall experience of users on the website, including page speed, navigation, and overall ease of use. Local SEO optimization involves optimizing the website for local search results, including elements such as the physical location of a business.

As an example, the SEO strategy, changes and optimization can be automatically determined and implemented using AI/ML (artificial intelligence/machine learning) to identify what SEO strategies and changes like keywords, HTML code and content changes would be true representation of the website as well as generate maximum traffic and engagement from end users of the website. Based on user traffic and engagement data and AI/ML models as feedback loop, the engine would recommend changes and auto generate SEO related changes including any or all of the above for maximizing traffic and engagement.

As another example, auto generation of SEO strategy may include utilizing a ML model to identify what keywords represent the website. A keyword search may then be executed on a very large dataset of user traffic and engagement to see traffic data. A predictive engine may then be used to predict the linkage of the keywords to user traffic. A recommendation engine may then determine which keywords should be prioritized. The auto generation engine would then take this recommendation and make changes to the actual website code without changing the original user content.

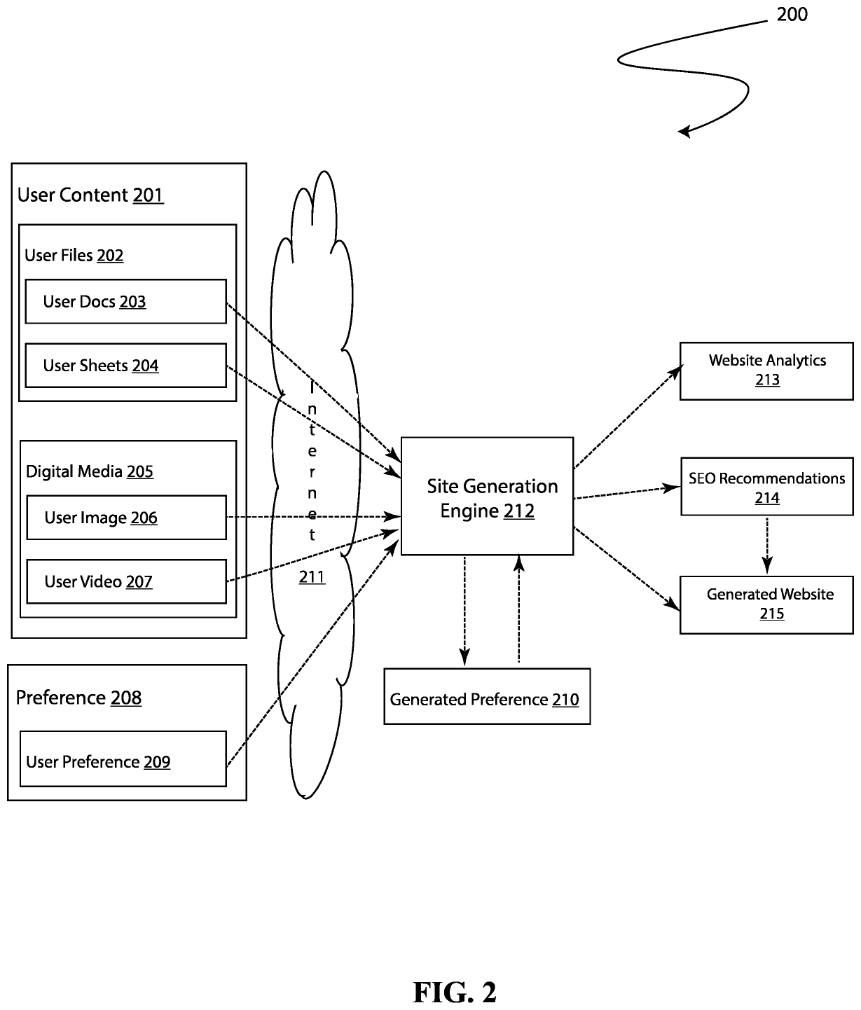

FIG. 2 is an example of a Site Generation Engine 212 generating a custom website based on User Content 201, Preference 208, and/or Generated Preference 210. Computer System 200 may include User Content 201, Preference 208, Generated Preference 210, Site Generation Engine 212, Generated Website 215, Website Analytics 213, and other components.

User Content 201 may include User Files 202, and Digital Media 205. It may also include other content types. The User Files 202 may include documents or User Docs 203 and/or User Sheets 204. User Docs 203 may also include links to other User Content like their social profiles, club signup interest page, user's website links, survey links, and other sources for user content. Digital Media 205 may include User Images 206, and/or User Videos 207. Digital Media 205 may also include audio files, clips, and other media types. User Content 201 may include other content like Google forms, and text files.

Preference 208 may include User Preference 209 specified by the User. User Preference 209 may tell the Site Generation Engine the design preference for the website, whether the website should be interactive or not, if it should have filters, other areas impacting the look and the interactivity of the website, and other design criteria.

A Site Generation Engine 212 may access the User Content 201 and Generate Preferences related to the design criteria of the file. As an example, if there is a vast amount of data in the User files, the Site Generation Engine may choose a design template that will provide filter functionality to the website User. This Generated Preference 210 would be fed back into the Site Generation Engine 212 to generate the final Website content.

The Site Generation Engine 212 may access the User Content 201 and Preference 208 across the Internet 211. User Content 201 could be in the form of User Files 202, and/or Digital Media 205, and/or other sources to auto generate a custom website. Preference 208 could be in the form of User Preference 209 which could be provided as user input or exist in a file. This content and Preference could then be used to generate and deploy a website. As an example. User Image 203 may include an image representing the school club for California Scholarship Federation; User Video 204 may include a video for American Red Cross; User Docs 206 may include a description of what the school club for California Scholarship Federation does; User Sheets 207 may include information for all School Clubs for school X. User Docs 206 or User Sheets 207 may include Facebook, Instagram, and Twitter links for California Scholarship Federation. It may also include links to an existing website for California Scholarship Federation or links to an interest form to join the California Scholarship Federation School Club. With this information, the Site Generation Engine 212 may auto generate a custom website including the HTML, CSS, JavaScript which can then be hosted as a custom Generated Website 215. It may also generate analytical code to provide Website Analytics 213 to the original user. It may also generate SEO Recommendations 214 to uprank the generated website upon search.

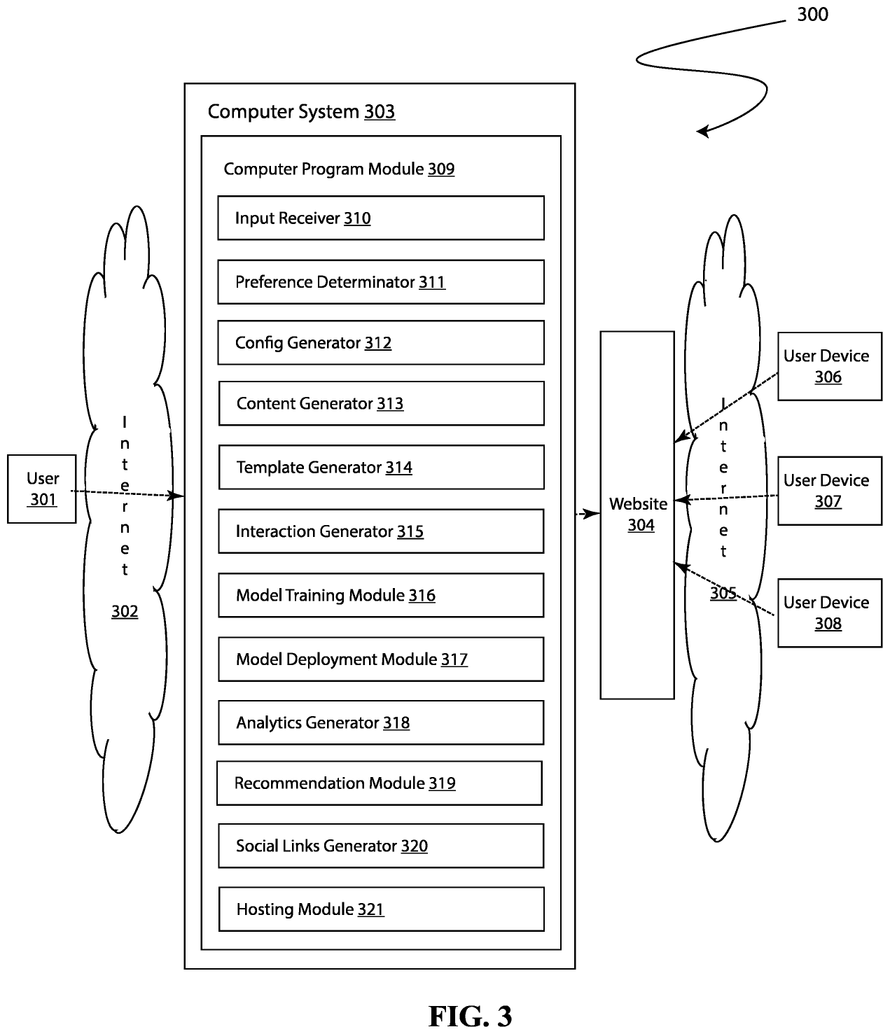

FIG. 3 is a functional block diagram of the Computer System 300 and modules that may be needed for generating a custom website. In a typical embodiment, System 300 may include User 301 trying to generate a website, Computer System 303 which includes the Computer Program Module 309 which in turn invokes different sub modules, the Generated Website 304 that can be accessed by multiple end users through different devices User Device 306, User Device 307, User Device 308 and more. These may be mobile devices, laptops, or others.

User 301 may access the Computer System 303 through the Internet 302. The Computer System 303 may consist of a Computer Program Module 309 that may serve as a driver module.

Computer Program Module 309 may call one or more sub modules. The sub modules may include Input Receiver 310, Preference Determinator 311, Config Generator 312, Content Generator 313, Template Generator 314, Interaction Generator 315, Model Training Module 316, Model Deployment Module 317, Analytics Generator 318, Recommendation Module 319, Social Links Generator 320, Hosting Module 321, and/or other sub modules.

Input Receiver 310 may receive input from a user to provide access to user content on a user device, or on the cloud, and to get user preference for the website generation. The User Content may include user files. As an example, the user files may be documents and google sheets, or Excel files. The file content may include personal user content that the user wants to share, or already shared user content. The user content may include digital media. As an example, the digital media may include one or more images, or videos. The user content may include personal content of the user. The personal content may include content that is currently accessible to the user and inaccessible to other users.

Preference Determinator 311 may determine user preference based on the user content. The user preference may be generated after accessing the user content. As an example, generating the user preference through accessing the user content may include determining the amount of varied data based on reading the user content, and determining the recommended design templates.

As an example, the user preference may include what design templates to use to auto generate the custom website. The user preference may also include letting the intelligent generation engine auto determine which template is best suited for the given user content. The User Preference may also include preference around the website having Interactive components and to what level. As an example, the user preference may specify a design template where filter functionality should be included. The engine itself could also infer this preference based on the huge amount of data in the user content file. From there, the calling module would determine that the JavaScript module would need to be invoked to generate the JavaScript file for filter functionality. The preference of the user may include one or both of a preference explicitly indicated by the user or an inferred preference.

Config Generator 312 may generate config information. In the software development world, a config file is considered a standard method for storing and managing configuration information for an application, system, or device. The purpose of a config file is to allow developers and users to modify the behavior and operation of the software or system without having to change the underlying code. The Config Generator may use this standard way of setting configuration for the custom website.

Config Generator 312 may generate a config file based on the user preferences and user content. Config Generator may also receive input from the Preference Determinator and generate the website files based on it. In a typical embodiment, Config Generator could generate a config file that receives input that the title of the website should be School X Clubs Website based on input received from the user. The Config Generator could also receive input from the Preference Determinator that the User Content has images allocated to each row in the Excel file and the best design template to use for this would be Template Y. The Config Generator would then create a config file specifying the Title as School X Clubs Website and design template to use as Template Y.

Content Generator 313 may generate the website content related components of a custom website based on the user content including Digital Media, User Files, and User Social Presence. FIG. 2, above, provides an illustration. As an example, Content Generator could generate an HTML file for school clubs based on the content in User specified Files, which would describe the purpose and details about all those clubs.

Template Generator 314 may receive user input from the Input Receiver and user content. The Template Generator may also receive the auto-determined preference from the Preference Determinator. The Template Generator may then generate the design template based on one of these preferences. As an example, Template Generator could generate a CSS file that controls the design of the website based on the determined preference.

Interaction Generator 315 may receive user input from Input Receiver and user content. The Interaction Generator may also receive the auto-determined preference from the Preference Determinator. The Interaction Generator may then generate the interaction component based on one of these preferences. As an example, Interaction Generator could generate a JavaScript file that controls the interactive components of the website based on the determined preference.

Model Training Module 316 may train a machine learning (ML) model to determine the SSO strategy and settings. The ML model may be used to analyze user traffic data and/or other information to determine the SEO strategy and settings. Model Deployment module 317 may deploy the ML model to auto-generate the SEO settings.

Analytics Generator 318 may track traffic and engagement of the created website, to generate better SEO settings and the website. Traffic and engagement may be utilized to optimize and auto generate SEO settings.

Recommendation Module 319 may recommend SEO strategies and settings based on AI, Model Training Module and Analytics Generator. The module would identify what SEO strategies and changes like keywords, HTML code and content changes would be true representation of the website as well as generate maximum traffic and engagement from end users of the website. Based on user traffic and engagement data and AI/ML models as feedback loop, it would recommend changes and auto generate SEO related settings including any or all of the SEO components for maximizing traffic and engagement.

As an example, auto generation of SEO strategy may include utilizing a ML model to identify what keywords represent the website. A keyword search may then be executed on a very large dataset of user traffic and engagement to see traffic data. A predictive engine may then be used to predict the linkage of the keywords to user traffic. A recommendation engine may then determine which keywords should be prioritized. The auto generation engine would then take this recommendation and make changes to the actual website code.

Social Links Generator 320 may generate further website content of a custom website based on the user content including User Social Presence. As an example, Social Links Generator could generate Facebook, Instagram icons for school clubs linking directly to their Facebook and Instagram pages based on the contents in User specified Files, which would have those direct links about all clubs.

Hosting Module 321 may automate the domain registration and website hosting flow. The module would host the final website, and the components required for tracking traffic and managing SEO, based on the user content and user preference.

Computer System 303 may include Computer Program Module 309, and other components. Illustration of Computer System 303 in FIG. 3 is an example. Computer System 303 may also include other additional software components to provide the functionality attributed to Computer System 303.

Computer Program Module 309 may provide all intelligence capabilities for Computer System 303. Computer Program Module 309 will in turn call one or more sub modules based on the required functionality. In some implementations, Computer Program Module 309 may execute one or more of the modules 310, 311, 312, 313, 314, 315, 316, 317, 318, 319, 320, 321, and/or other modules. One or more of the modules 310, 311, 312, 313, 314, 315, 316, 317, 318, 319, 320, and 321 may not need to get called, or there may be a need for additional modules.

The Computer Program Module 309 generates and hosts a Website 304, which may be accessed by users through the Internet 305. The users may access Website 304 through User Devices 306, 307, and 308 which may be laptops, mobile phones, tablets, or other devices.

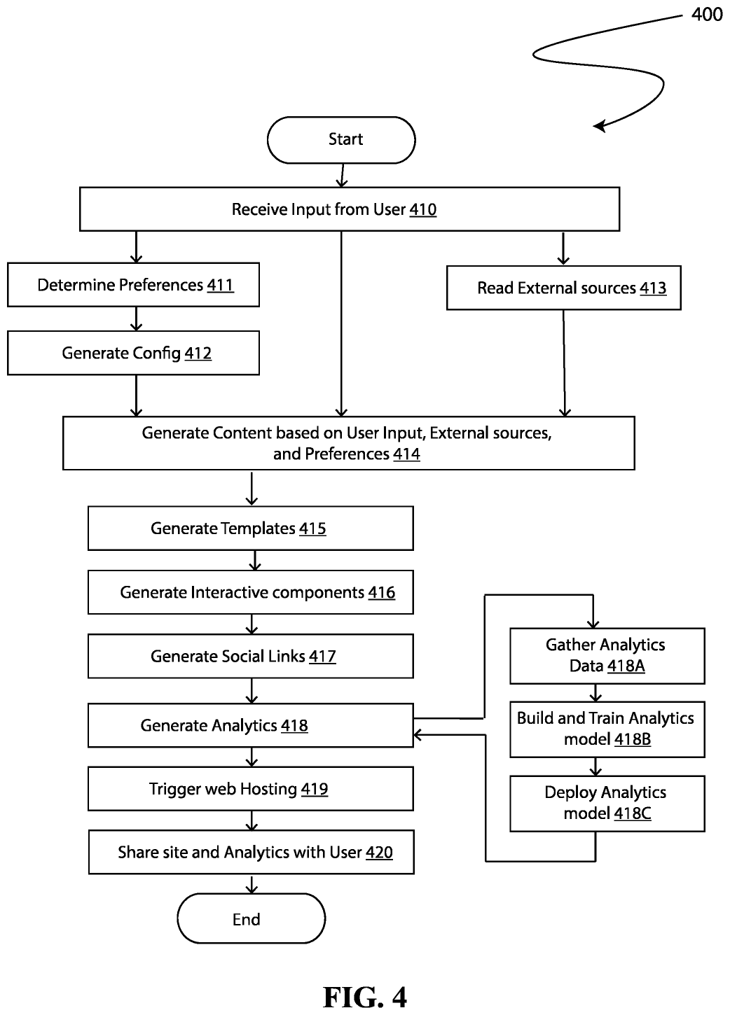

FIG. 4 is an example of a flow diagram for generating a custom website, based on user content, user preferences, available templates, and recommendation engine. It is an illustration of the process 400, for generating a custom website.

At the starting step 410, the process 400 may include receiving input from a user to provide access to user content on a user device, or on the cloud, and to get user preference for the website generation.

At step 411, the process 400 may determine user preference based on the user content.

At Step 412, the process 400 may generate a config file based on User Input and User Preferences and/or auto-determined preferences.

At Step 413, the process 400 may read external sources including documents, sheets, images, site links, form links, links, and other resources based on User Input.

At Step 414, the process 400 may generate custom website Content based on User Input, User content in external sources and User Preferences and/or auto generated content.

At Step 415, the process 400 may generate design templates which determine the look and feel and design of the website being generated.

At Step 416, the process 400 may generate the interactive components of the website being generated.

At Step 417, the process 400 may generate links to social media presence or other external links for the website being generated.

At Step 418, the process 400 may generate the analytics required for maximizing visibility and traffic for the website being generated. This may include the recommendations for Analytics and SEO settings. At Step 418A, the process 400 may gather analytics data and other usage data required for measuring traffic and impressions. At Step 418B, the process 400 may build and train the ML model that generates Analytics and SEO recommendations and settings. At Step 418C, the process 400 may deploy that ML model required for Analytics and SEO recommendations and settings.

At Step 419, the process 400 may trigger the web hosting flow based on User Input, User Preference and auto-determined preference.

At the last Step 420, the process 400 may share the website details, hosting details, and other Analytics and SEO related data and views to the original User requesting the website creation.

The above description of the invention has been provided for the purpose of illustration and explanation. It is not meant to be exhaustive or to limit the invention to the exact form described above. The operations depicted in the diagrams would not be limited to the exact order. The order in which modules get executed may change or some modules may be run in parallel to make the program more efficient. The embodiments described herein were chosen and described in order to best explain the principles of the invention and its practical application, thereby enabling others skilled in the art to understand the invention for various embodiments and with various modifications as are suited to the particular use contemplated. Other variations are within the scope of the following claims.

The invention claimed is:

1. A method for generating a custom website using a computer system, comprising the steps of:
receiving input from a user to provide access to user content, and to get user preference for the custom website;
determining user preferences based on the user content;
generating config based on the user content, user preferences and/or auto-determined preference;
generating website content based on the user content;
generating template based on the user content, user input, user preference and/or auto-determined preference;
generating interaction based on the user content, user input, user preference and/or auto-determined preference;
training a machine learning model to determine SSO strategy;
deploying a machine learning model to determine SSO strategy;
generating analytics for the website;
generating search engine optimization recommendations based on the user behavior, machine learning model, and AI recommendation engine;
generating social links based on the user input and user content;
hosting a custom website and sharing the custom website and analytics for the website with the original user; and
generating a custom website based on the user preferences, auto determined preferences, and user content.

2. The method of claim 1, wherein the user content comprises digital media, and user files; wherein digital media comprises one or more images, videos, video clips, social media posts, websites, blogs, audio clips, and/or other content.

3. The method of claim 1, wherein the user preference is generated through accessing the user content or user input.

4. The method of claim 1, further comprising:
User preference related to one or more of design preference, template preference, color preference, theme preference, visual and audio preference, and/or other preference;
Preference which is auto-generated based on content; and
Generating the website environment based on user preference or auto-determined preference.

5. The method of claim 1, wherein the config comprises user preference, auto-determined preference, user content, and other inputs determining the custom website.

6. The method of claim 1, wherein the website content comprises digital media, user files, and/or other links.

7. The method of claim 1, wherein the template comprises design aspects including, but not limited to color, font, theme, and more.

8. The method of claim 1, wherein the interaction comprises interactive functionality like sort, filter, on click and more.

9. The method of claim 1, wherein the social links comprises links to social media sites including Facebook, Instagram, Twitter, LinkedIn, TikTok, YouTube, Pinterest, SnapChat, and others.

10. The method of claim 1, wherein the analytics and search engine optimization further comprising:
measuring user behavior on generated website;
tracking performance of generated website;
building a machine learning model for SEO optimization variables and their linkage to user traffic; and
building an AI recommendation engine for SEO strategy, changes, and optimization.

11. The method of claim 1, wherein the user behavior comprises impressions, traffic, engagement, time spent, and other behavior measures on the website.

12. The method of claim 1, wherein the machine learning model and AI recommendation engine are utilized to generate SEO strategy, changes, and optimization.

13. A computer system for generating a custom website, comprising:
An input receiver configured to receive input from a user to provide access to user content, and to get user preference for the custom website;
A preference determinator configured to determine user preferences based on the user content;
A config generator configured to generate config based on the user content, user preferences and/or auto-determined preference;
A content generator configured to generate website content based on the user content;
A template generator configured to generate template based on the user content, user input, user preference and/or auto-determined preference;
An interaction generator configured to generate interaction based on the user content, user input, user preference and/or auto-determined preference;
A model training module configured to train a machine learning model to determine SSO strategy;
A model deployment module configured to deploy a machine learning model to determine SSO strategy;
An analytics generator configured to generate analytics for the website;
A recommendation module configured to generate search engine optimization recommendations based on the user behavior, machine learning model, and AI recommendation engine;
A social links generator configured to generate social links based on the user input and user content;
A hosting module configured to host a custom website and share the custom website and analytics for the website with the original user; and
A computer program module configured to generate a custom website based on the user preferences, auto determined preferences, and user content.

14. The computer system of claim 13, wherein the custom website components comprise the website user facing and non user facing content, user design and other preferences, auto determined preference, design components, interactive website components, analytics for the website, and/or settings for analytics and SEO for the website.

15. The computer system of claim 13, wherein the preference is generated by the preference determinator through accessing the user content or user input.

16. The computer system of claim 13, further comprising:
User preference related to one or more of design preference, template preference, color preference, theme preference, visual and audio preference, and/or other preference;
Preference which is auto-generated based on content; and
Generating the website environment based on user preference or auto-determined preference.

17. The computer system of claim 13, wherein the social links generated by social links generator, comprises links to social media sites including Facebook, Instagram, Twitter, LinkedIn, TikTok, YouTube, Pinterest, SnapChat, and others.

18. The computer system of claim 13, wherein the analytics and search engine optimization further comprising:
measuring user behavior on generated website;
tracking performance of generated website;
building a machine learning model for SEO optimization variables and their linkage to user traffic; and
building an AI recommendation engine for SEO strategy, changes, and optimization.

19. The computer system of claim 13, wherein the user behavior generated by analytics generator, comprises impressions, traffic, engagement, time spent, and other behavior measures on the website.

20. The computer system of claim 13, wherein the machine learning model and AI recommendation engine generated by model training module, model deployment module, and recommendation module, are utilized to generate SEO strategy, changes, and optimization.
